(19) United States
(12) Patent Application Publication
(10) Pub. No.: US 2013/0294001 A1
(43) Pub. Date: Nov. 7, 2013

(54) ELECTROMAGNETIC SWITCHING APPARATUS

(71) Applicant: Yusuke Moriguchi, Osaka (JP)

(72) Inventor: Yusuke Moriguchi, Osaka (JP)

(73) Assignee: PANASONIC CORPORATION, Osaka (JP)

(21) Appl. No.: 13/980,006

(22) PCT Filed: Mar. 8, 2012
(86) PCT No.: PCT/JP2012/055912

§ 371 Date: Jul. 16, 2013

(30) Foreign Application Priority Data
Mar. 22, 2011 (JP) 2011-063264

(51) Int. Cl. H01H 47/22

(52) U.S. Cl. CPC H01H 47/22
USPC 361/179

(57) ABSTRACT

An electromagnetic switching apparatus includes a contact block to be inserted in an electric path, an electromagnet block for driving the contact block, the electromagnet block being configured to drive the contact block to close the electric path so as to become conductive when an excitation current is supplied from outside, a normally-closed type switch member inserted in a supply path of the excitation current, an acquisition unit configured to obtain an impact detection signal from an impact sensor that is configured to detect an impact, and a control unit configured, based on the impact detection signal obtained by the acquisition unit, to turn off the switch member so as to break the supply path when the impact sensor detects an impact of which magnitude is larger than a predetermined threshold.

### TECHNICAL FIELD

The invention relates to an electromagnetic switching apparatus such as an electromagnetic relay.

### BACKGROUND ART

Recently, it has become more popular the vehicles equipped with a battery and a motor energized by an energy stored in the battery, such as electric vehicles and hybrid vehicles (and plug-in hybrid vehicles). This vehicle includes an electromagnetic switching apparatus for making (closing) and breaking (opening) a power supply path from the battery to the motor.

For instance, JP2009-230921A (hereinafter, referred to as “patent document 1”) discloses a kinds of the electromagnetic switching apparatuses used for such the purpose. The electromagnetic switching apparatus of the patent document 1 includes a relay unit (electromagnetic relay) housed in a plastic case, and the case is protrudingly provided with: a pair of main terminals connected to a contact section of the relay unit; and a pair of coil terminals connected to an electromagnet coil of the relay unit. The main terminals are adapted to be connected to a power supply path between the battery and the motor. The coil terminals are adapted to be connected to a control device (ECU; electric control unit) of a vehicle. The control device is configured to turn on the relay unit (electromagnetic switching apparatus) by applying an excitation current across the coil terminals, and turn off the relay unit (electromagnetic switching apparatus) by not applying the excitation current to the coil terminals. The power supply path from the battery to the motor is made (closed) when the electromagnetic switching apparatus is turned on. The power supply path is broken (opened) when the electromagnetic switching apparatus is turned off.

In the vehicle, it is desirable, from the viewpoint of safety, that the control device of the vehicle is configured to turn off the electromagnetic switching apparatus to disconnect the battery from the power supply path when the vehicle is caused an accident. However, some severe damage of the vehicle caused by an accident might cause a situation that the control device cannot turn off the electromagnetic switching apparatus. Not only a vehicle such as an electric vehicle, but also other portable or movable device equipped with a battery such as a laptop computer have similar problem.

### DISCLOSURE OF THE INVENTION

The invention is developed in view of above problem, and it is an object of the invention to improve a safety when being subject to impact.

An electromagnetic switching apparatus of the invention includes a contact block to be inserted in an electric path, an electromagnet block for driving the contact block, the electromagnet block being configured to drive the contact block to close the electric path so as to become conductive when an excitation current is supplied from outside, a normally-closed type switch member inserted in a supply path of the excitation current, an acquisition unit configured to obtain an impact detection signal from an impact sensor that is configured to detect an impact, and a control unit configured, based on the impact detection signal obtained by the acquisition unit, to turn off the switch member so as to break the supply path when the impact sensor detects an impact of which magnitude is larger than a predetermined threshold.

It is preferable that the electromagnetic switching apparatus further includes a signal terminal adapted to be inputted the impact detection signal.

It is preferable that the electromagnetic switching apparatus further includes a case which houses therein the contact block, the electromagnet block, the switch member, the acquisition unit, and the control unit. The impact sensor is housed in the case.

It is preferable that the electromagnetic switching apparatus further includes a power reception terminal for receiving from outside an electric power to be supplied to the switch member as drive power.

It is preferable that the electromagnetic switching apparatus further includes a case which houses therein the contact block, the electromagnet block, the switch member, the acquisition unit, and the control unit, and a power source which is housed in the case and configured to supply drive power to the switch member.

The electromagnetic switching apparatus includes the control unit configured to turn off the switching member to interrupt the excitation current thereby breaking the electric path when being subject to impact from outside. The electromagnetic switching apparatus therefore has an advantage of having an improved safety when being subject to an impact.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 shows an embodiment of the invention, and FIG. 1A is a circuit block diagram thereof and FIG. 1B is an appearance diagram thereof;

FIG. 2 shows a circuit block diagram of an embodiment of another configuration.

### BEST MODE FOR CARRYING OUT THE INVENTION

An electromagnetic switching apparatus of an embodiment according to the invention is described with reference to the drawings.

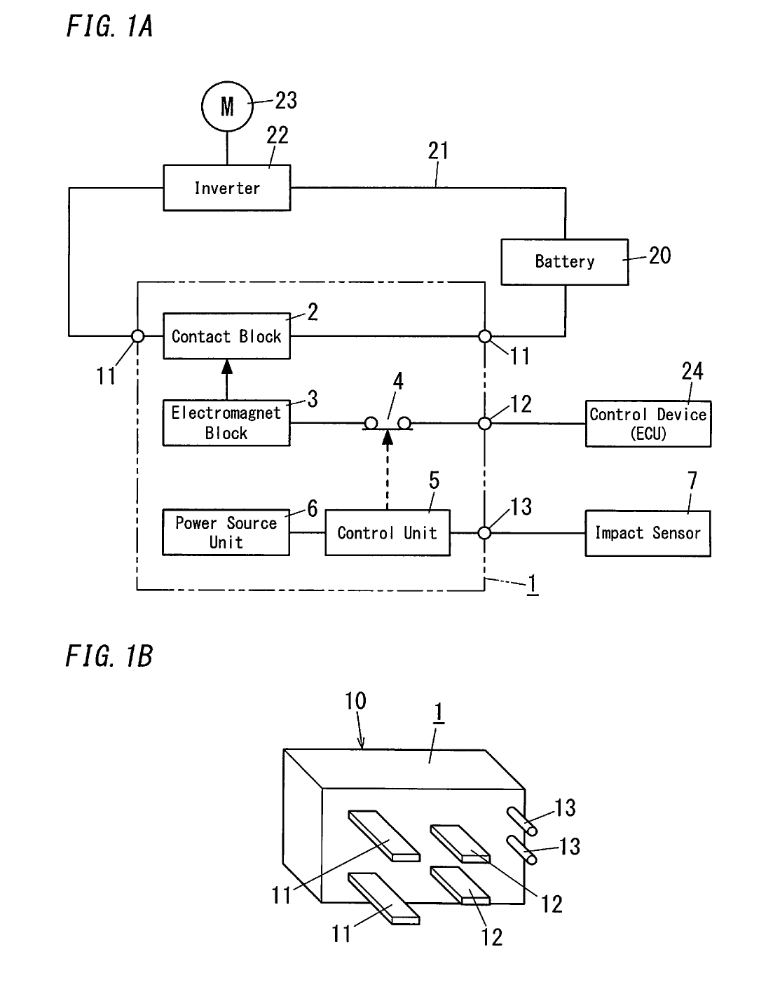

The electromagnetic switching apparatus 1 of the embodiment is adapted for use in an electric vehicle or the like, as shown in FIG. 1A. The vehicle includes: a battery 20; an inverter 22 configured to convert a DC (direct current) power supplied from the battery 20 through an electric path (electric circuit) 21 into an AC (alternate current) power; a motor 23 energized by the AC power from the inverter 22; and a control device (ECU) 24.

The electromagnetic switching apparatus 1 includes: a case 10 having rectangular box shape; and a contact block 2, an electromagnet block 3, a switch member 4, a control unit 5, and a power source unit 6 which are housed in the case 10 (see FIG. 1B). The case 10 is provided with a pair of main terminals 11, a pair of coil terminals 12, and a pair of signal terminals 13 protruded from one surface thereof into a same direction. The main terminals 11 are adapted to be connected to the electric path 21. The coil terminals 12 are adapted to be connected to the control device 24. The signal terminals 13 are adapted to be connected to an impact sensor 7.

The impact sensor 7 is configured to detect an impact (acceleration) applied on the vehicle, and to output a voltage signal (impact detection signal) related to the magnitude of the detected impact into the signal terminals 13 of the electromagnetic switching apparatus 1. The impact sensor 7 may be constituted by a well-known acceleration sensor, and detailed explanation thereof is omitted.

The contact block 2 includes: a fixed contact connected to one of the main terminals 11; a fixed contact connected to the other of the main terminals 11; a movable armature configured to be made in contact with and out of contact from the fixed contacts; a contact spring; and so on. The electromagnet block 3 includes: an excitation coil; a fixed core; a movable core; a movable shaft; a return spring; and so on. The contact block 2 and the electromagnet block 3 have well-known structures of such units. When the excitation coil is not supplied with an excitation current, the electromagnet block 3 does not serve as an electric magnet, and the movable armature is kept apart from the fixed contacts due to an attracting force through the movable shaft. In this time, the contact block 2 is kept open so as to break an electric path. When the excitation coil is supplied with an excitation current, the electromagnet block 3 functions as an electrical magnet to move the movable core and the movable shaft by generating a magnetic force between the movable core and the fixed core, and thereby the movable armature is made in contact with the fixed contacts. In this time, the contact block 2 is kept close so as to make an electric path. The excitation current is supplied from outside (e.g., from the control device 24) through the coil terminals 12. That is, in the embodiment, the control device 24 controls whether the electromagnetic switching apparatus 1 is turned on or off (i.e., the contact block 2 is closed or opened).

For example, the switch member 4 is constituted by an electromagnetic relay of normally-closed type (normally on type). The switch member 4 is inserted in a supply path of the excitation current between the coil terminal 12 and the electromagnet block 3. Under a condition where the switch member 4 is turned on, the contact block 2 (i.e., electromagnetic switching apparatus 1) is switched between an ON state and an OFF state in response to the control (ON and OFF) of the excitation current by the control device 24. On the other hand, under a condition where the switch member 4 is turned off, the contact block 2 (i.e., electromagnetic switching apparatus 1) is kept an OFF state regardless of the instruction of the control device 24. Note that, FIG. 1A omits the illustration of one of a pair of supply lines between the control device 24 and the electromagnet block 3 as well as a coil terminal 12 inserted in the line. Switch members 4 may be inserted in the respective supply lines between the electromagnet block 3 and the control device 24, or a switch member 4 may be inserted in either one of the supply lines.

In the embodiment, the switch member 4 is constituted by a normally-closed type switch, and therefore the switch member 4 is kept automatically turned on when the magnitude of an impact detected by the impact sensor 7 is smaller than a predetermined upper limit. That is, there requires no electric power for turning on the switch member 4. Therefore, the embodiment can reduce electricity consumed in the switch member 4 and the control unit 5.

The control unit 5 is constituted by a logic circuit, a microcomputer, or the like. The control unit 5 is provided separately from the control device 24 of the vehicle. The control unit 5 is configured, based on an impact detection signal from the signal terminals 13, to drive to turn off the switch member 4 when an impact of which magnitude is larger than the upper limit (predetermined threshold) is detected by the impact sensor 7, and configured not to drive the switch member 4 when the magnitude of an impact detected by the impact sensor 7 is smaller than the upper limit. That is, the control unit 5 has a function of an acquisition unit in the embodiment. The embodiment is not limited to a configuration that the impact detection signal is inputted from the impact sensor 7 directly to the signal terminals 13, and the detection signal may be inputted to the signal terminals 13 through the control device 24. However, it is preferable that the impact detection signal is inputted from the impact sensor 7 directly to the signal terminals 13, in the light of a possibility of failure of the control device 24.

The impact sensor 7 may be configured to output a signal that reflects the magnitude of a detected impact, as the impact detection signal. In this configuration, the control unit 5 turns off the switch member 4 in response to that when receiving a signal indicative of that the impact sensor 7 detects an impact of which magnitude is larger than a predetermined upper limit (threshold).

Alternatively, the impact sensor 7 may be configured to output an impact detection signal only when detecting an impact of which magnitude is larger than a predetermined upper limit (threshold). (i.e., the impact sensor 7 does not output the impact detection signal when the magnitude of detected impact is smaller than the predetermined upper limit.) In this configuration, the control unit 5 turns off the switch member 4 in response to a reception of the impact detection signal (by the control unit 5 as an acquisition unit).

The power source unit 6 supplies operation power to the control unit 5 and the switch member 4. The power source unit 6 may be constituted by a primary battery such as a dry-cell battery or a button battery. A power reception terminal may be provided on the case 10, as substitute for providing the power source unit 6. In this configuration, the operation power is supplied from outside (e.g., battery 20 of the vehicle) through the power reception terminal.

An operation of the electromagnetic switching apparatus 1 of the embodiment is described below. When the vehicle runs normally, the switch member 4 is kept turned on, because the magnitude of impact detected by the impact sensor 7 does not exceed the upper limit.

When the vehicle is subject to a large impact due to an accident such as a crash of the running vehicle against other vehicles or an obstacle, the magnitude of impact detected by the impact sensor 7 may exceed the upper limit. In this case, the control unit 5 drives the switch member 4 to turn off, and thereby the supply path of an excitation current from the coil terminal 12 to the electromagnet block 3 is broken to interrupt the excitation of the electromagnet block 3. In this time, the contact block 2 is opened to break an electric path. As a result, the electromagnetic switching apparatus 1 autonomously turns off to break the electric path 21, in spite of the presence or absence of the instruction of the control device 24. The embodiment therefore has an improved safety when being subject to an impact.

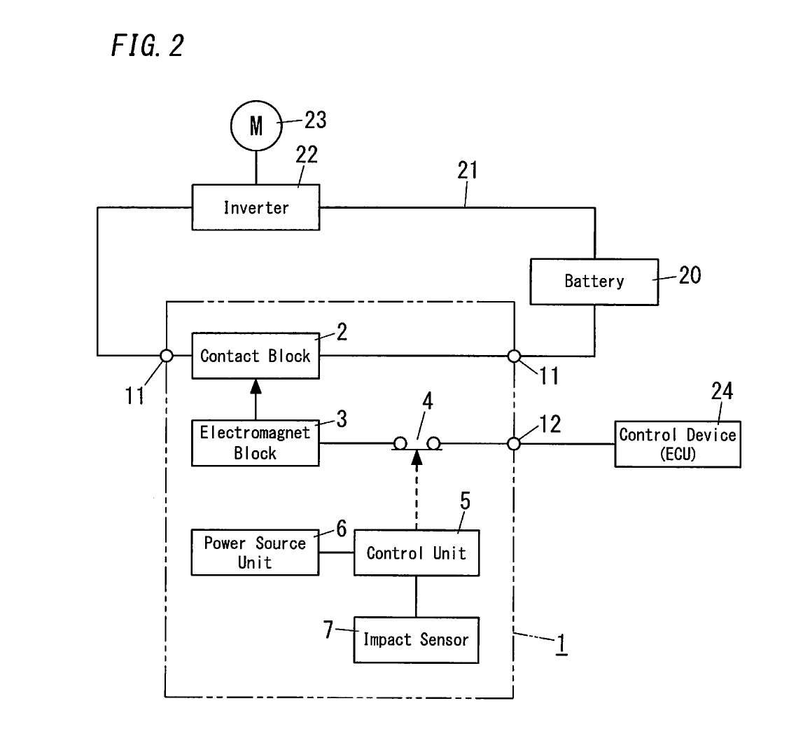

Note that, the impact sensor 7 may be housed in the case 10 as shown in FIG. 2. The configuration, which the impact sensor 7 is housed in the case 10, can omit signal terminals 13 and signal lines connecting the signal terminals 13 and the impact sensor 7, and has an advantage of saving the effort of a wiring work. Note that, in the other configuration where the impact sensor 7 is not housed in the case 10, there is an advantage that the impact sensor 7 can be installed in the vehicle at a suitable place for detecting impact, such as at a bumper.

In the embodiment, the electromagnetic switching apparatus 1 is provided on a vehicle such as an electric vehicle, but is not limited thereto. For example, the electromagnetic switching apparatus 1 can be preferably provided on a portable or movable device equipped with a battery, such as a laptop computer.

Although the present invention has been described with reference to certain preferred embodiments, numerous modifications and variations can be made by those skilled in the art without departing from the true spirit and scope of this invention, namely claims.

1. An electromagnetic switching apparatus comprising:
a contact block to be inserted in an electric path;
an electromagnet block for driving the contact block, the electromagnet block being configured to drive the contact block to close the electric path so as to become conductive when an excitation current is supplied from outside;
a normally-closed type switch member inserted in a supply path of the excitation current;
an acquisition unit configured to obtain an impact detection signal from an impact sensor that is configured to detect an impact; and
a control unit configured, based on the impact detection signal obtained by the acquisition unit, to turn off the switch member so as to break the supply path when the impact sensor detects an impact of which magnitude is larger than a predetermined threshold.

2. The electromagnetic switching apparatus as set forth in claim 1, further comprising a signal terminal to which the impact detection signal is inputted.

3. The electromagnetic switching apparatus as set forth in claim 1, further comprising a case which houses therein the contact block, the electromagnet block, the switch member, the acquisition unit, and the control unit,
wherein the impact sensor is housed in the case.

4. The electromagnetic switching apparatus as set forth in claim 1, further comprising a power reception terminal for receiving from outside an electric power to be supplied to the switch member as drive power.

5. The electromagnetic switching apparatus as set forth in claim 3, further comprising a power reception terminal for receiving from outside an electric power to be supplied to the switch member as drive power,
wherein the power reception terminal is provided on the case.

6. The electromagnetic switching apparatus as set forth in claim 1, further comprising:
a case which houses therein the contact block, the electromagnet block, the switch member, the acquisition unit, and the control unit, and
a power source which is housed in the case and configured to supply drive power to the switch member.

7. The electromagnetic switching apparatus as set forth in claim 2, further comprising a power reception terminal for receiving from outside an electric power to be supplied to the switch member as drive power.

8. The electromagnetic switching apparatus as set forth in claim 2, further comprising:
a case which houses therein the contact block, the electromagnet block, the switch member, the acquisition unit, and the control unit, and
a power source which is housed in the case and configured to supply drive power to the switch member.

9. The electromagnetic switching apparatus as set forth in claim 3, further comprising:
a case which houses therein the contact block, the electromagnet block, the switch member, the acquisition unit, and the control unit, and
a power source which is housed in the case and configured to supply drive power to the switch member.
